(19) United States
(12) Patent Application Publication
(10) Pub. No.: US 2007/0114846 A1
(43) Pub. Date: May 24, 2007

(54) Power supply circuit for removable automotive interior systems with integrated position sensor system

(76) Inventor: Slobadan Pavlovic, Canton, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/286,528

(22) Filed: Nov. 23, 2005

(51) Int. Cl. B60L 1/00

(52) U.S. Cl. 307/9.1

(57) ABSTRACT

An electrical power supply system is provided that includes a vehicle interior trim member selectably mountable to a vehicle interior. The trim member includes an electrical load device and a releasable connector for receiving electrical energy for powering the electrical load device. A power supply connector is electrically coupled to a power supply and releasably attachable to the releasable connector. A switching circuit determines a position of the releasable connector relative to the power supply connector. The releasable connector is connected to the power supply connector when the trim member is selectively attached to the vehicle and is disconnected from the releasable connector when the trim member is detached from the vehicle. The switching circuit disconnects power from the power supply connector when the proximity of the releasable connector relative to the power supply connector is outside of a predetermined range and connects power when within the predetermined range.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates in general to a vehicle interior power supply connections for interior trim members of a vehicle, and more specifically, to a disconnectable power supply circuit for a detachable interior trim member of a vehicle such as a seat.

2. Description of the Related Art

Vehicle interior systems such as passenger seats are removable from a vehicle and/or stowable in the vehicle. Vehicle seats which include electrical load devices such as heating elements or motors for moving portions of the seats require power be supplied to the vehicle seat through an electric connection. Typically the floor area is the only suitable location for making the electrical connection between a power supply connector and a releasable connector incorporated within the vehicle seat. For vehicle seats that are removable, stowable, or pivotal to a tilt forward position, a mating portion of the electrical connection must also be detachable to allow the vehicle seat to be removed, stowed, or pivoted fully forward.

While providing an electrical connection which automatically connects and disconnects the mating connectors when the vehicle seat is removed from its position, power is still supplied to an exposed power supply connector. The exposed electrical contact is susceptible to a short circuit caused by the electrical contacts coming into contact with a foreign object or by a person, in addition by damage caused by impacts to the contact from the person or object. Furthermore, being that the electrical connection to a vehicle seat is typically made at the floor level, an exposed connector may be susceptible to debris and liquids spilled on the floor which may lead to the corrosion or damage to the electrical contact.

### BRIEF SUMMARY OF THE INVENTION

This invention has the advantage of determining whether an electrical connection is made between two mating connectors of an electrical supply circuit for supplying power to an electric device within an interior trim member of a vehicle. The electrical supply circuit disconnects power to the power supply connector when the proximity of the releasable connector relative to the power supply connector is outside of a predetermined range that indicates that the connectors are disconnected.

In one aspect of the present invention, an electrical power supply system is provided that includes a vehicle interior trim member selectably mountable to a vehicle interior. The vehicle interior trim member includes an electrical load device and a releasable connector for receiving electrical energy for powering the electrical load device. The releasable connector includes a high impedance element having an impedance within a predetermined range less than an open circuit impedance. A power supply connector is fixedly mounted to the vehicle interior and adapted to be electrically coupled to a power supply. The power supply connector is also releasably attachable to the releasable connector for supplying electrical energy from the power supply to the electrical load device. A switching circuit determines a position of the power supply connector relative to the releasable connector and selectively energizes the power supply connector in response to the sensed position. The releasable connector is connected to the power supply connector when the vehicle interior trim member is selectively attached to the vehicle and is disconnected from the releasable connector when the vehicle interior trim member is selectively detached from the vehicle. The switching circuit disconnects power from the power supply connector when a proximity of the releasable connector relative to the power supply connector is outside of the predetermined range. The switching circuit connects power to the power supply connector when the proximity of the releasable connector relative to the power supply connector is within the predetermined range.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a view of a interior compartment of a vehicle illustrating detachable interior trim members according to a preferred embodiment of the present invention.

FIG. 2 is a perspective view of the power supply connector according to a first preferred embodiment of the present invention.

FIG. 3 is a perspective view of the male terminal contacts of the power supply connector according to a first preferred embodiment of the present invention.

FIGS. 4a and 4b are perspective views of the releasable connector according to a preferred embodiment of the present invention.

FIG. 5 is an illustration of the connection of the power supply connector and the releasable connection preferred embodiment of the present invention.

FIG. 6 is an electrical schematic of the electrical supply system circuit according to a preferred embodiment of the present invention.

FIG. 7 is a method for powering on and off the power supply connector according to a preferred embodiment of the present invention.

### DETAILED DESCRIPTION OF THE PREFERRED EMBODIMENT

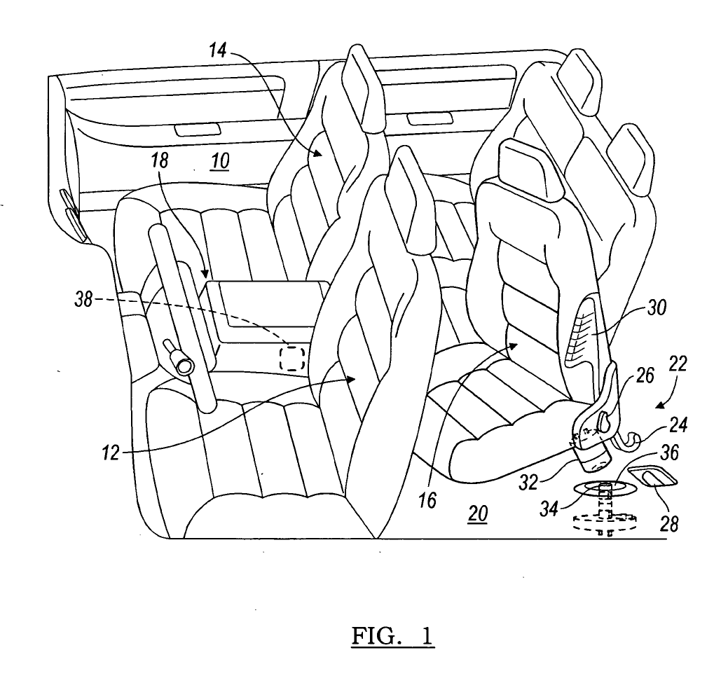

Referring now to the drawings, there is illustrated in FIG. 1 an interior of a vehicle shown generally at 10. The interior of the vehicle 10 includes a driver's seat 12, a front passenger's seat 14, a rear passenger seat 16, and a front center console 18 that are mounted to a vehicle floor shown generally at 20.

The rear passenger seat 16 includes a latch mechanism 22 disposed on a bottom corner of the rear passenger seat 16. The latch mechanism 22 includes a latch 24 and latch release lever 26. The latch mechanism 22 is typically spring-loaded to allow the latch to move into position for engaging a catch 28 mounted in the vehicle floor 20. The latch 24 is unlatched for allowing the rear passenger seat to be moved. For example, the rear passenger seat 16 may be pivoted forward to allow a person access to the rear of the rear passenger seat 16, stowing the rear vehicle seat 16 in a stowable compartment (not shown), or removing the rear passenger seat 16 from the vehicle interior.

The rear passenger seat 16 further includes an electrical load device 30, such as a vehicle seat warmer. The electrical load device 30 may further other types of electrical load devices such as a seat motor for adjusting a backrest or lumbar. A releasable connector 32 is mounted on a bottom portion of the vehicle seat 16 for receiving and supplying power to the electrical load device 30 and is moveable with the rear passenger seat 16 as the seat is moved.

The vehicle floor 20 includes a power supply connector 34 for providing power to the releasable connector 32 when electrically coupled. The power supply connector 34 is fixedly mounted in the vehicle floor 20. Preferably, the power supply connector 34 is recessed below the floor 20 such as in a pilot hole 36. Recessing the power supply connector 34 below the floor 20 prevents the power supply connector 34 from being damaged by impacts.

The releasable connector 32 of the rear vehicle seat 16 is in electrical contact with the power supply connector 34 when rear vehicle seat 16 is in a latched position. As the rear passenger seat 16 is moved to the latch position, the releasable connector 32 extends into the pilot hole 36 and mates the power supply connector 34 recessed below the floor 20. This not only prevents the connection of the power supply connector 34 and the releasable connector 32 from being damaged by contact but also prevents a person or object from contacting the electrical connection when energized.

FIG. 1 further shows an interior trim member such as the front center console 18 that is detachable from the vehicle interior compartment 10. The front center console 18 may include an electrical load device such as a multimedia device (i.e., DVD player for viewing movies or a CD magazine rack for playing audio). The front center console 18 or a portion thereof may be detachable to allow the electrical load device to be removed from the vehicle. The front center console 18 includes an electrical connection, shown generally at 38, that is similar to the electrical connection described above. When the front center console 18 is mounted to the floor 20 or other adjacent structure, an electrical connection is made between the two mating connectors. When the front center console 18 is detached from the floor 20 or other adjacent structure, the center console power supply connector is recessed within the floor 20 to avoid contact or interference with any exterior objects or passengers.

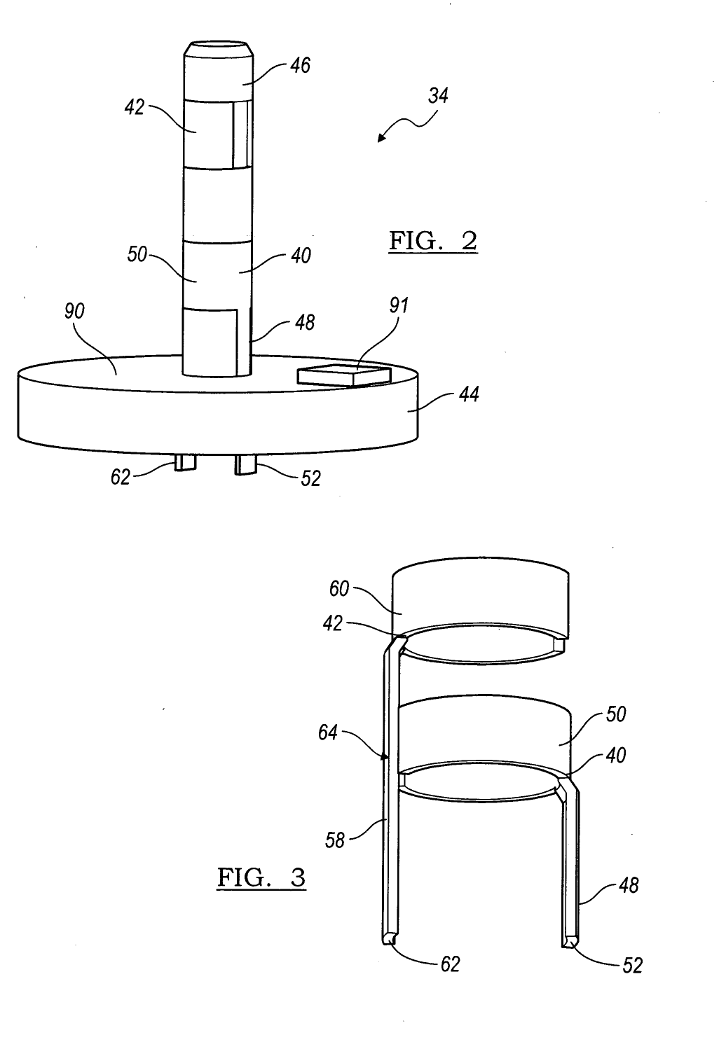

FIG. 2 illustrates a perspective view of the power supply connector 34. The power supply connector 34 includes a first male terminal contact 40 and a second male terminal contact 42 for supplying electrical energy from a power supply device (e.g., vehicle battery) to a female mating connector. The power supply connector 34 includes a circular base portion 44 integrally formed with a guide post 46.

A position sensor 91 is disposed on a top surface 90 of the circular base portion 44. Preferably the position sensor 91 is a Hall Effect sensor. Alternatively, the position sensor may include an inductive sensor or an RFID reader.

Referring to both FIGS. 2 and 3, the first male terminal contact 40 includes a longitudinal section 48 that is integrally formed to a ring portion 50 that is open ended. The ring portion 50 is retained about the circumference of the post 46. The post 46 may include a notched portion in which the ring portion 50 is inserted therein. Alternatively, the open ended ring portion 50 may be insert-molded as part of the post 46. The longitudinal section 48 extends axially along the post 46 and through the circular base portion 44. An end 52 of the longitudinal section 48 protrudes from a bottom portion the circular base portion 44 for connecting to a wire or harness (not shown) for receiving voltage from the designated power source.

The second male terminal contact 42 includes a longitudinal section 58 that is integrally formed to a ring portion 60 that is open ended. The ring portion 60 is retained about the circumference of the post 46 and is spaced axially in relation to the first ring portion 50. The post 46 may include a notched portion in which the ring portion 60 is inserted therein. Alternatively, the ring portion 60 may be insert-molded as part of the post 46. The longitudinal section 58 extends axially along the post 46 and through the circular base portion 44. An end 62 of the longitudinal section 58 protrudes from the bottom portion of the circular base portion 44 for connecting to a wire or harness (not shown) for receiving voltage from a designated power source.

An open end 64 of the ring portion 50 provides an axial passage for allowing the longitudinal section 58 of the second male terminal contact 42 to extend past the open ended ring portion 50 without contacting and shorting the first male terminal contact 40 to the second male terminal contact 42.

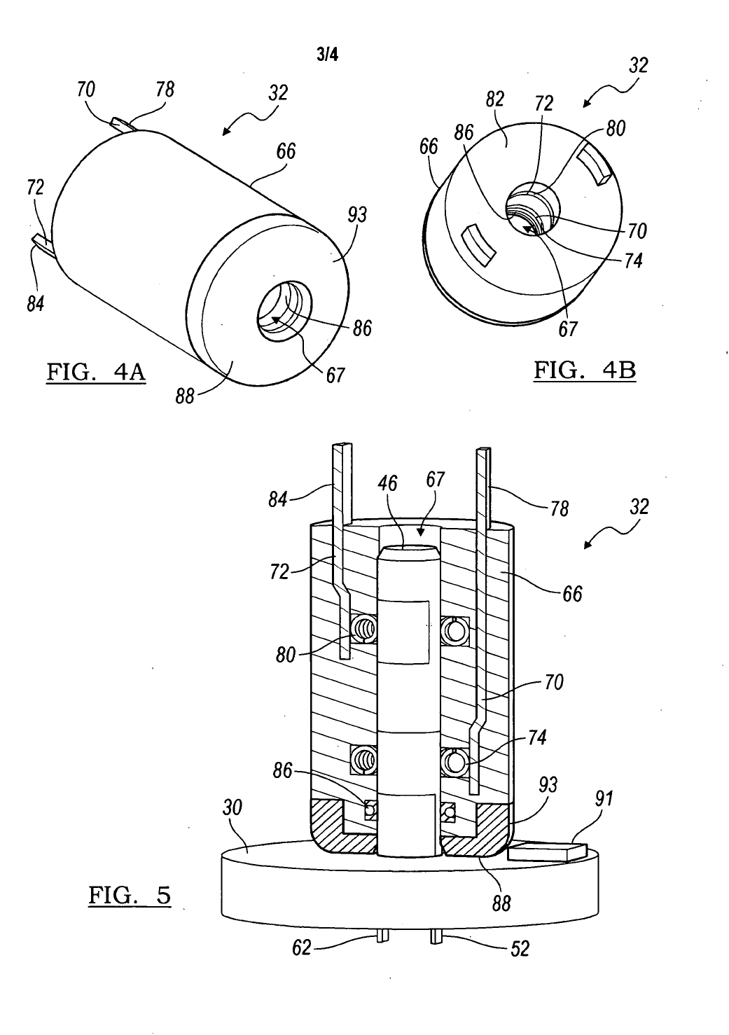

FIGS. 4a and 4b illustrate perspective views of the releasable connector 32. The releasable connector 32 includes a main body 66 made from a nonconductive material. The main body 66 includes an inner bore 67 that extends axially through the main body 66. The releasable connector 32 includes a first female terminal contact 70 that includes a conductive circular member 74 that in electrical contact with a conductive longitudinal member 78. The releasable connector 32 further includes a second female terminal contact 72 which includes a conductive circular member 80 in electrical contact with a conductive longitudinal member 84. The first female terminal contact 70 and second female terminal contact 72 are insert-molded into the main body 66 and are exposed to the inner bore 67.

An end portion 88 includes magnet 93, preferably a permanent magnet. The magnet 93 may be insert molded to the main body 66 or coupled to the main body 66 by another method. The magnet 93 generates a magnetic field in the vicinity of the end portion 88 that is sensed by the position sensor 91 of the male terminal contact 34.

Alternatively, if an inductive sensor is used, a metal shield is utilized in place of the magnet for expelling the magnetic field and changing the coil inductance of the inductive sensor. The changing of the coil inductance indicates the proximity of the power supply connector relative to the releasable connector.

In yet another alternative embodiment, an RFID circuit may be utilized to sense the proximity of the power supply connector relative to the releasable connector. The RFID circuit may be configured differently for sensing the electrical interconnection connection of two devices. The sensing of the interconnection of two devices using an RFID circuit is shown in co-pending application entitled “System and Method For Verifying Assembly Of Manufactured Parts Using RFID Tags”, Ser. No. 11/162,957 filed Sep. 29, 2005, which is incorporated by reference herein. An example of utilizing the RFID circuit is to dispose an RFID tag in the releasable connector and dispose the RFID reader in the power supply connector. The reader powers the tag when the tag is in close proximity to the reader. The tag when powered by the reader responds to an interrogation pulse, thereby identifying the proximity of the two mating connectors. Alternatively, the electrical connection between the power supply connector and the releasable connector may be used to perform an electromechanical switching function within an RFID tag portion of the circuit. The RFID tag portion includes an open loop antenna with a transponder. An open circuit in the antenna loop when the accessory is removed will prevent the reader from powering the tag (transponder) so that the tag is incapable of responding to the reader. A closed circuit in the RFID tag portion when the accessory is attached will allow the reader to power the tag (transponder) so that it may respond to the reader. A response from the tag to the reader would indicate an electrical connection is occurring between the power supply connector and the releasable connector whereas a non-response would indicate that some other conductive object is inadvertently making the connection. Power would be connected to the power supply connector if a response is received and power would be disconnected from the power supply connector if a non-response is received.

A circular seal 86 is disposed within the main body 66 near the end portion and is exposed to the inner bore 67. The seal 86 prevents contaminants from entering the connection between the power supply connector 34 and the releasable connector 32 from the end potion 88. The seal 86 also wipes the male terminal contacts as the post 46 is inserted within the inner bore 67.

FIG. 5 illustrates the connection between the releasable connector 32 and the power supply connector 34. The first female terminal contact 70 includes the conductive circular member 74 which is a spring-like member that has radial retention properties for contacting the post 46 when inserted within the conductive circular member 74. The conductive circular member 74 and the conductive longitudinal member 78 may be integrally formed or may be held in electrical contact with one another by the main body 66. The conductive longitudinal member 78 extends axially within the main body 66. The conductive longitudinal member 78 protrudes through an end surface 82 for electrically coupling to a respective conduit for supplying voltage to the electrical load device 30 within the interior trim member.

The second female terminal contact 72 includes the conductive circular member 80 which is a spring-like member that has retention properties when the post 46 is inserted within the conductive circular member 80. The conductive circular member 80 and the conductive longitudinal member 84 may be integrally formed or may be held in contact with one another by the main body 66. The conductive longitudinal member 84 extends axially within the main body 66. The conductive longitudinal member 84 protrudes through an end surface 82 for electrically coupling to a respective conduit for supplying voltage to the electrical load device within the interior trim member.

The seal 86 is seated within the main body 66 and is exposed to the inner bore 67 near an end portion 88 of the releasable connector 32 for preventing debris from entering the end portion 88 when the power supply connector 30 and the releasable connector 32 are coupled.

The post 46 of the power supply connector 30 positioned on a bottom portion of the rear passenger seat 16 is seated within the bore 67 of the releasable connector 32 when the rear passenger seat 16 is in a secured position to the floor 20. When the post 46 enters the bore 67 from the end portion 88, the post 46 as well as the first and second male terminal contacts 40 and 42 makes contact with the seal 86 as the post 46 moves through the bore 67. As the first and second terminal male contacts 40 and 42 slidingly contact the seal 86, fluid and debris are wiped from each respective contact. As the end portion 88 of the power supply connector 34 bottoms out against a top surface 90 of the circular base portion 44, the first male terminal contact 42 is in electrical contact with the first female terminal contact 70 and the second male terminal contact 42 is in electrical contact with the second female terminal contact 72. Both conductive circular members 74 and 80 exert and inward radial force against the ring portions 50 and 60 for maintaining an electrical connection when the electrical load device 30 is activated. Power is provided to the electrical load device 30 within the rear passenger seat 16 via the mating electrical contacts.

Power is connected to the power supply connector 34 when the releasable connector 32 is within a proximal position of the releasable connector 32. The magnet 91 generates an electromagnetic field about an end portion 88 of the releasable connector 32. This is accomplished by the position sensor 91 sensing the electromagnetic field of the magnet 93. The position sensor 91 senses the intensity of the electromagnetic field generated by the magnet 93 as the releasable connector 32 is inserted over the power supply connector 34. As the magnet 91 is moved closer to the position sensor 91, the intensity of the electromagnetic field is increased. When the intensity of the electromagnetic field reaches a predetermined threshold as sensed by the position sensor 91, power is connected to the power supply connector 34. If the intensity of the electromagnetic field is outside of the predetermined threshold, then power is disconnected from the power supply connector 34.

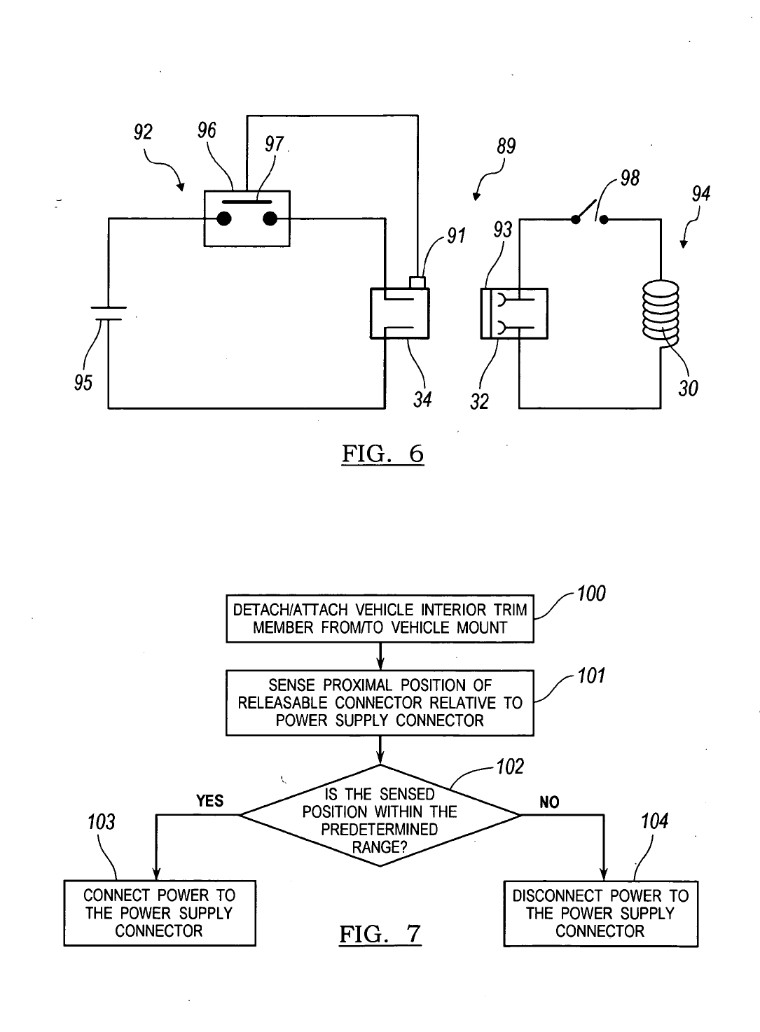

FIG. 6 illustrates a schematic of an electrical supply system 89. The electrical supply system 91 includes a power supply circuit 92 and a releasable supply circuit 94. The power supply circuit 92 includes a power supply source 95, a switching circuit 96, and the power supply connector 34. The power supply source 95 may be an energy storage device such as a battery or an energy generating device such as an alternator. In the preferred embodiment, the power source 95 is electrically connected between the switching circuit 96 and the power supply connector 34. The switching circuit 96 includes a position sensor 91 that senses the proximal position of the releasable connector relative to the power supply connector seen by the switching circuit 96. The switching circuit 96 includes a re-settable controlled switch 97, solid state fuse, or other device which be used connect or disconnect power between the power source 95 and the power supply connector 34. Alternatively the controlled switch 97 or like device may be disposed in a power distribution box (not shown).

The releasable supply circuit 94 includes the releasable connector 32, a device switch 98, and the electrical load device 30. The releasable connector 32 is selectively connectable with the power supply connector 34 for receiving power from the power supply circuit 92. The releasable connector 32 also includes a magnet 93 for generating an electromagnetic field.

The position sensor 91 senses the electromagnetic field as generated by the magnet 93 when the releasable connector 34 is moved within a proximal distance of the power supply connector 32. This distance correlates to the intensity of the electromagnetic field. The stronger the intensity of the electromagnetic field, the closer the proximity of the position sensor 91 to the magnet 93, and as a result, the closer the releasable connector 34 is to being fully seated on the power supply connector 34. When the position sensor 91 senses that the intensity of the electromagnetic field reaches a predetermined threshold, a presumption is made that the vehicle interior trim component 16 is attached to the vehicle interior 20 and that the releasable connector is seated or at least substantially seated on the power supply connector 34. The switching circuit 96 connects power to the power supply circuit 34 which is thereby supplied to the electrical device 30 via the releasable connector 32 in response to the sensed electromagnetic field intensity being at or above the predetermined threshold.

FIG. 7 illustrates a method for connecting and disconnecting power to the power supply connector in response to the sensed electromagnetic field. In step 100, the vehicle interior trim member is in either the latched or unlatched position. In step 101, the position sensor senses the-position of the releasable connector relative to the power supply connector (e.g., by the intensity of the electromagnetic field). In step 102, a determination is made as to whether the position of the releasable connector and the power supply connector are within a predetermined threshold. If the determination is made that the sensed position is within the predetermined threshold, then power to the power supply connector is connected in step 103. If the sensed position is not within the predetermined threshold, then power to the power supply connector is disconnected in step 104. It should be noted that the sensed position may be determined by the intensity of the electromagnetic field, the sensed inductance, or a interrogation response from a RFID tag.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. An electrical power supply system comprising:
a vehicle interior trim member selectably mountable to a vehicle interior, said vehicle interior trim member including an electrical load device and a releasable connector for receiving power for powering said electrical load device;
a power supply connector fixedly mounted to and recessed below a vehicle floor in said vehicle interior, adapted to be electrically coupled to a power supply and releasably attachable to said releasable connector for supplying power from said power supply to said electrical load device; and
a switching circuit for determining a proximal position of said releasable connector relative to said power supply connector and for selectively energizing said power supply connector in response to said sensed position;
wherein said releasable connector is connected to said power supply connector when said vehicle interior trim member is selectively attached to said vehicle and is disconnected from said power supply connector when said vehicle interior trim member is selectively detached from said vehicle, wherein said switching circuit disconnects power from said power supply connector when a proximity of said releasable connector relative to said power supply connector is outside of a predetermined threshold, and wherein said switching circuit connects power to said power supply connector when said proximity of said releasable connector relative to said power supply connector is within said predetermined threshold.

2. The system of claim 1 wherein releasable connector includes a magnet for generating an electromagnetic field and said power supply connector includes a sensor for sensing said electromagnetic field, and wherein said proximity position of said releasable connector relative to said power supply connector is determined in response to said sensor sensing an intensity of said electromagnetic field.

3. The system of claim 1 wherein said proximity of said power supply connector relative to said releasable connector outside of said predetermined range corresponds to an open circuit as a result of said releasable connector being disconnected from said power supply connector.

4. The system of claim 1 further comprising a controlled switch for selectively coupling power between said power supply and said power supply connector.

5. The system of claim 4 wherein said controlled switch is disposed within said switching circuit.

6. The system of claim 1 wherein said switching circuit is coupled to a position sensor that senses a proximal position of said power supply connector relative to said releasable connector.

7. The system of claim 6 wherein said position sensor includes a Hall Effect sensor.

8. The system of claim 6 wherein said position sensor includes an inductive sensor.

9. The system of claim 6 wherein said position sensor includes a RFID reader and said releasable connector includes an RFID tag.

10. A method for controlling power coupled to a power supply connector of an electrical supply system for powering an electrical load device disposed within a vehicle interior trim member, wherein said power is disconnected from said power supply connector when said vehicle interior trim member is selectively detached from a vehicle interior mount, and wherein said power is supplied to said power supply connector when said vehicle interior trim member is selectively attached to said vehicle interior mount, said method comprising the steps of:
providing a releasable connector electrically connected to said electrical load device of said vehicle interior trim member for receiving power from said power supply connector recessed below a vehicle floor, wherein said releasable connector and said power supply connector are electrically coupled when said vehicle interior trim member is selectively attached to said vehicle interior mount, and wherein said power supply connector and said releasable connector are decoupled when said vehicle interior trim member is selectively detached from said vehicle interior mount;
sensing a position of said releasable connector relative to said power supply connector;
determining whether said sensed position is within a predetermined range; and
disconnecting power to said power supply connector when said sensed position is outside of said predetermined range.

11. The method of claim 10 wherein said predetermined range comprises an electromagnetic field intensity range.

12. The method of claim 11 wherein said step of disconnecting power in response to said sensed position being outside of said predetermined range comprises generating an electromagnetic field and sensing whether said electromagnetic field is within said predetermined range.

13. The method of claim 10 further comprising the step of connecting power to said power supply connector when said sensed position is within said predetermined range.

14. The method of claim 10 wherein a switching circuit is coupled between a power supply and said power supply connector for controlling power to said power supply connector.

15. The method of claim 14 wherein a controlled switch within said switching circuit disconnects power to said power supply connector.

16. The method of claim 10 wherein a position sensor senses said position of said releasable connector relative to said power supply connector.

17. The method of claim 16 wherein said position sensor includes a Hall Effect sensor.

18. The method of claim 16 wherein said position sensor includes an inductive sensor.

19. The method of claim 16 wherein said position sensor includes a wireless RFID reader for reading information transmitted from a RFID tag disposed in said releasable connector.

20. The method of claim 19 wherein said coupling of said power supply connector and said releasable connector provides a closed antenna loop for enabling said RFID tag to receive power from said RFID reader.
